(19) United States
(12) Patent Application Publication
(10) Pub. No.: US 2026/0132015 A1
(43) Pub. Date: May 14, 2026

(54) Fuel Filling Device and Vehicle Fuel Tank Filling Assembly

(71) Applicant: STAUBLI FAVERGES, Faverges-Seythenex (FR)

(72) Inventors: Igor Bahno, Albertville (FR); Christophe Durieux, Gilly Sur Isere (FR)

(21) Appl. No.: 19/388,866

(22) Filed: Nov. 13, 2025

(30) Foreign Application Priority Data
Nov. 14, 2024 (FR) 2412437

(51) Int. Cl. B67D 7/34; B67D 7/04; B67D 7/36

(52) U.S. Cl. CPC B67D 7/344; B67D 7/04; B67D 7/36

(57) ABSTRACT

The present disclosure relates to a filling device coupled with an end. The device includes a ball holder and a locking ball movable between retracted and locking positions. A valve is movable in the ball holder between rear and front positions. A locking ring is movable between a blocking position that maintains the locking ball in the locking position, and an unlocking position. A coupling ball is movable between a first position that prevents the valve from reaching its front position, and a second position. A drawer is pushed by the end between an engaged position that maintains the locking ball in the retracted position, and a disengaged position. An elastic member displaces the drawer to its engaged position, and an elastic member displaces the locking ring to its blocking position.

### FIELD

The present invention relates to a fuel filling device and a vehicle fuel tank filling assembly comprising such a filling device.

### BACKGROUND

The connection assemblies for liquid fuel filling of competition vehicles, notably two-wheelers, include a filling end capable of being connected to filling devices.

It is notably known from EP1526319 to use female filling elements provided with a detection member of the end, by pressing on a fixed part of the end, which controls the radial displacement of a mobile locking hook between a release position and a gripping position on the end. The body of the female element then abuts on the end. The hook releases a locking ring which, by its advancement relative to the female body, locks the female element with the end and ultimately causes the opening of the fuel and vent valves of the female element, by pushing back an end valve.

The locking/unlocking functions and the opening/closing functions of the valves are performed in a single movement, and positively by the operator, so that the steps related to locking and the filling steps are not distinguishable. The non-differentiation of the filling and locking steps could lead to the activation of filling while the device is poorly locked, which could cause leaks.

On the other hand, the actuation of the locking with the opening of the valves is carried out by manipulating roller handles, which may seem tedious.

The aim of the invention is therefore to propose a fuel filling device making it possible to improve the locking function, and to provide configurable safety functions for vehicle fuel filling while ensuring the safety of the operator.

### SUMMARY

To this end, the invention relates to a fuel filling device configured to be coupled with an end connected to a vehicle tank, the filling device comprising:

a ball holder, comprising:

a tubular ball holder body, extending along a main axis between a rear part and a front part of the ball holder body, the front part defining a receiving mouth of the end,

a tubular valve seat, extending in the receiving mouth of the ball holder body along the main axis,

at least one locking ball, received in a first radial housing provided in the front part of the ball holder body, and mobile in the first radial housing between a retracted position and a locking position wherein:

said at least one locking ball is radially less eccentric relative to the main axis than in the retracted position, and

said at least one locking ball protrudes into the receiving mouth,

a valve, comprising:

a valve body, which is tubular and extends along the main axis between a front end of the valve body, and a rear end of the valve body, the valve body defining an external radial valve surface and forming a flow channel capable of being fluidly connected to a rear filling line of the valve,

a distribution passage, connected to the flow channel and provided radially to the main axis at the front of the valve body, and

the valve being mounted in the ball holder so that:

the external radial valve surface is in contact with an inner surface of the ball holder body,

the valve is mobile in translation along the main axis relative to the ball holder between a rear position, wherein the valve seat closes the distribution passage, and a front position, wherein the distribution passage of the valve is clear,

a tubular locking ring surrounding the ball holder and being mobile between:

a blocking position, wherein the locking ring is capable of maintaining said at least one locking ball in the locking position, and

an unblocking position wherein said at least one locking ball is free to reach the retracted position,

at least one coupling ball, axially integral with the ball holder and mobile radially to the main axis between:

a first position, wherein said at least one coupling ball prevents the valve from reaching its front position, said at least one coupling ball being maintained in the first position when the locking ring is in the unblocking position, and

a second position, wherein said at least one coupling ball allows the displacement of the valve towards its front position,

a drawer, mobile in an annular space defined between an outer surface of the valve seat and the inner surface of the front part of the ball holder body, the drawer being configured to be pushed by the end along the main axis between:

an engaged position wherein the drawer is capable of maintaining said at least one locking ball in the retracted position, and

a released position wherein said at least one locking ball is free to reach its locking position,

a first elastic member capable of displacing the drawer from its released position to its engaged position, and

a second elastic member capable of displacing the locking ring from its unblocking position to its blocking position.

By means of the invention, notably thanks to the locking ring, the locking phase of the filling device is secured. Indeed, in case of misalignment of the filling device, said at least one locking ball prevents the advancement of the locking ring, which prevents the valve from opening. Thus, the risks of leakage in case of poor connection are avoided. Moreover, the presence of the second elastic member allows locking, without the need for external effort, and makes it possible to maintain the device locked on the end. Thus, the locking is secured.

According to other advantageous aspects of the invention, the fuel filling device comprises one or more of the following features, taken individually or in any technically possible combination:

the second elastic member rests on the ball holder;

in the engaged position of the drawer, said at least one locking ball in the retracted position is capable of maintaining the locking ring in the unblocking position;

the external radial valve surface is configured to maintain said at least one coupling ball in its second position when the valve is in the front position;

the filling device comprises a third elastic member capable of displacing the valve towards its rear position, and of maintaining the valve in the rear position when the drawer moves from the engaged position to the released position;

the filling device comprises a maneuvering ring, mounted around the locking ring and mobile in translation along the main axis, between a forward position and a backward position between which the maneuvering ring can drive the locking ring from its blocking position to its unblocking position;

the external radial valve surface comprises at least one groove extending parallel to the main axis, said at least one groove being capable of receiving said at least one coupling ball and allowing, when said at least one coupling ball is in its first position, a translation of the valve relative to the ball holder along the main axis over a range defined by a longitudinal length of said at least one groove;

the ball holder comprises at least one second radial housing provided at the rear of the first radial housing, said at least one coupling ball being capable of translating between its first and second positions through said at least one second radial housing and the locking ring comprises an internal groove configured to receive said at least one coupling ball in its second position so that said at least one coupling ball maintains the locking ring in the blocking position;

the filling device comprises safety means configured to take a first configuration and a second configuration so that, when the safety means are in their first configuration, the safety means are capable of driving the locking ring from the blocking position to the unblocking position in a backward movement of the valve between an intermediate position, located relative to the ball holder between the front position and the rear position, and the rear position;

when the safety means are in their second configuration, the displacement of the locking ring from the blocking position to the unblocking position is independent of the backward movement of the valve between its front position and its rear position;

the safety means comprise a safety ball mobile in an oblong housing of the ball holder, protruding radially on each side of the oblong housing, and forming an axial stop for the valve relative to the ball holder in the rear position of the valve;

the locking ring comprises an internal groove configured to receive the safety ball, so that the locking ring is driven from the blocking position to the unblocking position by the safety ball resting on the valve during the backward movement of the valve, between its front position and its rear position;

the filling device comprises means for securing the maneuvering ring with the locking ring, rotationally around the main axis, the safety means changing from their first to their second configuration by a rotational movement of the maneuvering ring relative to the ball holder;

the drawer rests axially on the ball holder in its released position;

when the valve is in the front position, the valve seat and the valve form an annular space fluidly connected to a vent channel provided at the rear of the device.

The invention also relates to a vehicle fuel tank filling assembly, the assembly comprising an end, configured to be carried on the vehicle and connected to a vehicle tank, and a filling device as defined above capable of being coupled to the end, the end comprising:

a body of the end configured to push the drawer of the filling device from its engaged position to its released position during a coupling of the end and the filling device, the body of the end comprising an external peripheral groove capable of receiving said at least one locking ball, when said at least one locking ball is in the locking position, and

a valve mobile axially in the body of the end between a forward position, wherein the valve rests on a sealing seat of the body of the end, and a retracted position, wherein the valve is away from the sealing seat.

### BRIEF DESCRIPTION OF THE DRAWINGS

The invention will become clearer upon reading the following description, given solely by way of non-limiting example, and made with reference to the drawings wherein:

FIG. 1 is a sectional view of a filling assembly, wherein a filling device in a first configuration is decoupled from an end.

FIG. 2 is a perspective view of a ball holder and a locking ring of the filling device shown in FIG. 1.

FIG. 3 is a view similar to FIG. 1, the filling device being brought closer to the end to prepare a coupling.

FIG. 4 is a view similar to FIG. 1, the filling device being in a first locking step.

FIG. 5 is a view similar to FIG. 1, the filling device being in a second locking step.

FIG. 6 is a view similar to FIG. 5, the filling device and the end being misaligned.

FIG. 7 is a view similar to FIG. 1, the filling device being locked to the end.

FIG. 8 is a view similar to FIG. 1, the filling device being in a filling phase.

FIG. 9 is a view similar to FIG. 1, the filling device being in an automatic unlocking phase.

FIG. 10 is a view similar to FIG. 1, the filling device being unlocked from the end.

FIG. 11 is a view similar to FIG. 9, the filling device being in a second configuration.

FIG. 12 is similar to FIG. 10, the filling device being in a second configuration.

### DETAILED DESCRIPTION

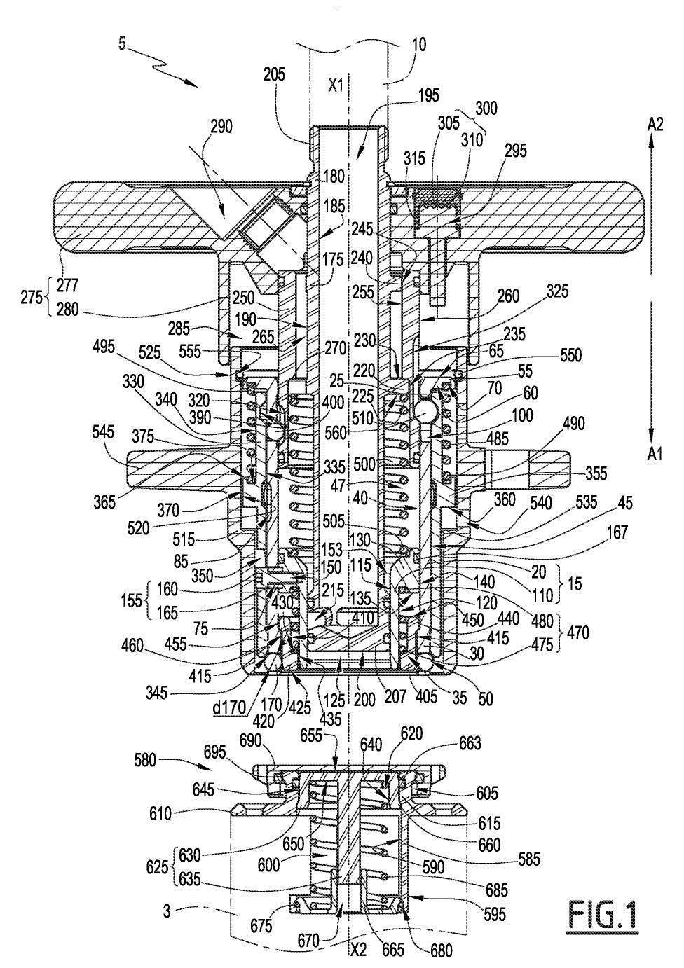

A fuel filling assembly 1 according to the invention is shown in FIGS. 1 to 12. The fuel filling assembly 1 is configured to fill a vehicle tank 3 (not shown) with fuel.

The filling assembly 1 is composed of a filling device 5, called a female element or female connector. The filling device 5 is intended to be attached to a filling line 10.

The filling device 5 comprises a ball holder 15. The ball holder 15 comprises a ball holder body 20. The ball holder body 20 is tubular and centered around a main axis X1. The ball holder body 20 extends along the main axis X1, between a rear part 25 and a front part 30. The front part 30 defines a receiving mouth 35.

The ball holder body 20 is delimited by an inner surface 40 and an external radial surface 45. The inner surface 40 is preferably radial to the main axis X1 and delimits an internal volume 47 of the ball holder body 20.

For the present description, terms such as "axial," "radial," and "longitudinal" are defined relative to the main axis X1. In this case, for example, an "axial surface" extends perpendicularly to the main axis X1, a "radial surface" extends parallel to the main axis X1 and around the main axis X1. Terms such as "front" and "distal" refer to a forward direction A1 extending from the rear part 25 towards the front part 30 parallel to the main axis X1. Terms such as "rear" and "proximal" refer to a rearward direction A2 opposite to the forward direction A1. A "front surface" is facing in the forward direction A1, a "rear surface" is facing in the rearward direction A2. Terms such as "interior," "internal," "exterior," and "external" are defined relative to the main axis X1. In this case, for example, "an internal surface" is oriented towards or closer to the main axis X1 and "an external surface" is oriented away from the main axis X1 or further from the main axis X1.

The ball holder body 20 has at least one first radial housing 50. In this example, about twenty first radial housings 50 are provided in the front part 30. Each of the first radial housings 50 extends radially through the front part 30 of the ball holder body 20. The first radial housings 50 are centered and evenly distributed around the main axis X1.

The rear part 25 comprises a crown 55. The crown 55 extends radially to the main axis X1 from the external radial surface 45 in a direction opposite to the main axis X1. The crown 55 defines an axial surface 60 facing in the forward direction A1 and an axial surface 65 opposite to the axial surface 60.

The crown 55 has a circular axial groove 70. The circular axial groove 70 is provided in the axial surface 60 and is centered around the main axis X1.

The ball holder body 20 also has four drillings 75. Each of the drillings 75 extends radially through the ball holder body 20. The drillings 75 are centered and evenly distributed around the main axis X1. The drillings 75 are provided between the first radial housings 50 and the rear part 25 relative to the main axis X1.

The external radial surface 45 of the ball holder body 20 has pairs of longitudinal grooves 80 located between the drillings 75 and the rear part 25. In this example, five pairs of longitudinal grooves 80 are provided on the external radial surface 45. The pairs of longitudinal grooves 80 extend parallel to the main axis X1. The pairs of longitudinal grooves 80 are centered and evenly distributed around the main axis X1. Each of the pairs of longitudinal grooves 80 comprises a longitudinal groove 85 and a second longitudinal groove 90 angularly spaced by about ten degrees around the main axis X1.

Advantageously, the ball holder body 20 comprises at least one second radial housing 95 provided at the rear, in the rearward direction A2, of the first radial housing 50. More specifically, the at least one second radial housing 95 is provided at the rear, in the rearward direction A2, of the pairs of longitudinal grooves 80. In this example, five second radial housings 95 are provided on the ball holder body 20. Each of the second radial housings 95 extends radially through the ball holder body 20. The second radial housings 95 are centered and evenly distributed around the main axis X1.

Advantageously, the ball holder body 20 comprises at least one oblong housing 100. In this example, five oblong housings 100 are provided on the ball holder body 20. Each of the oblong housings 100 extends radially through the ball holder body 20 and extends parallel to the main axis X1. The oblong housings 100 are centered and evenly distributed around the main axis X1. More specifically, the oblong housings 100 and the second radial housings 95 are centered and evenly distributed around the main axis X1 with an alternation of the oblong housings 100 and the second radial housings 95.

The ball holder 15 also comprises a valve seat 110. The valve seat 110 is tubular and centered around the main axis X1. The valve seat 110 is delimited by an internal radial surface 115 and an external surface 120 which is preferably radial to the main axis X1. The internal radial surface 115 delimits an internal volume 125 of the valve seat 110.

The valve seat 110 comprises a collar 130. The collar 130 extends radially to the main axis X1 from the external surface 120 in a direction opposite to the main axis X1. The collar 130 defines an axial surface 135 facing in the forward direction A1 and an external radial surface 140.

The collar 130 has a circular axial groove 145. The circular axial groove 145 is provided in the axial surface 135 and is centered around the main axis X1.

The first collar 130 also has four drillings 150. Each of the drillings 150 extends radially from the external radial surface 140 towards the main axis X1. The drillings 150 are centered and evenly distributed around the main axis X1.

The valve seat 110 is mounted in the internal volume 47 of the ball holder body 20, the external radial surface 140 being in contact with the inner surface 40 so that the valve seat 110 extends into the receiving mouth 35. The receiving mouth 35 and the valve seat 110 thus form an annular space 153 at the front of the ball holder 15 centered on the axis X1. The annular space 153 narrows towards the front. More specifically, the annular space 153 is defined between the inner surface 40 and the external surface 120.

The valve seat 110 is mounted from the rear part 25 into the internal volume 47 of the ball holder body 20 and moved in the forward direction A1 until the drillings 150 are respectively in line with the drillings 75.

The valve seat 110 is secured to the ball holder body 20 by means of four stop fingers 155 respectively consisting of a screw 160 and a clamping ring 165. Each of the stop fingers 155 is screwed into a respective drilling 75 and a respective drilling 150.

The sealing of the mounting of the valve seat 110 in the ball holder body 20 is ensured by an O-ring 167 positioned between the inner surface 40 and the external radial surface 140.

The filling device 5 comprises at least one locking ball 170. In this example, the filling device 5 comprises about twenty locking balls 170. Each of the locking balls 170 is respectively received in a first radial housing 50. The locking balls 170 have a diameter d170 greater than a thickness e20 of the ball holder body 20 and protrude from the radial housings 50.

The locking balls 170 are mobile in their respective first radial housing 50 between a retracted position and a locking position. In their respective locking position, each of the locking balls 170 is radially less eccentric relative to the main axis than in its retracted position, and the locking ball 170 protrudes into the receiving mouth 35.

The first radial housings 50 have, respectively, a housing bottom (not shown) to limit the fall of the locking balls 170 towards the main axis X1.

In the following description, the ball holder 15 is considered as a fixed element of the filling device 5, the other components of the filling device 5 being mobile or fixed relative to the ball holder 15.

The filling device 5 comprises a valve 175. The valve 175 comprises a valve body 180. The valve body 180 is tubular and centered around the main axis X1. The valve body 180 is delimited by an internal radial surface 185 and an external radial surface 190. The internal radial surface 185 delimits a flow channel 195.

The valve body 180 extends, parallel to the main axis X1, between a front end 207 and a rear end 205. The front end 207 comprises a front axial face 200, which is flat and perpendicular to the main axis X1. The axial face 200 extends radially to the axis X1 throughout the internal volume 47 and closes the flow channel 195 at the front end 207.

The rear end 205 is provided with a thread intended to be screwed to the rear filling line 10 of the valve 175, connected to a fuel storage system (not shown).

The valve 175 also comprises a distribution passage 215. The distribution passage 215 is provided radially to the main axis X1 through the front end 207 of the valve body 180. The flow channel 195 opens into the distribution passage 215.

The valve body 180 comprises a collar 220. The collar 220 extends radially to the main axis X1 from the external radial surface 190 in a direction opposite to the main axis X1. The collar 220 defines an axial surface 225 facing in the forward direction A1, an axial surface 230 opposite to the axial surface 225, and an external radial surface 235 connecting the axial surface 225 to the axial surface 230. The collar 220 is provided on the valve body 180 between the distribution passage 215 and the rear end 205 relative to the main axis X1.

The valve body 180 comprises a collar 240. The collar 240 extends radially to the main axis X1 from the external radial surface 190 in a direction opposite to the main axis X1. The collar 240 defines an external radial surface 245. The collar 240 is provided on the valve body 180 between the collar 220 and the rear end 205 relative to the main axis X1.

The valve 175 also comprises a central body 250. The central body 250 is tubular and centered around the main axis X1. The central body 250 is delimited by an internal radial surface 255 and an external radial valve surface 260. The internal radial surface 255 delimits an annular passage 265.

The central body 250 is mounted from the rear on the valve body 180. The internal radial surface 255 is in contact with the external radial surface 235 and the external radial surface 245. A shoulder 270 of the central body 250 is in front abutment with the axial surface 230 blocking the translation of the central body 250 parallel to the main axis X1 in the forward direction A1.

The valve comprises a handle 275 mounted around the valve body 180 along the main axis X1. The handle 275 has a wheel 277 and a peripheral annular partition 280 integral with the wheel 277 and extending from the wheel 277 in the forward direction A1. The peripheral annular partition 280 forms, in the forward direction A1, a front chamber 285. The central body 250 is at least partially received in the front chamber 285.

The handle 275 also comprises a vent channel 290. The vent channel 290 is provided in the wheel 277 and opens into the annular passage 265. The vent channel 290 is inclined relative to the main axis X1.

A housing 295 is provided in the wheel 277. The housing 295 extends through, parallel to the main axis X1, the wheel 277 and opens into the front chamber 285.

The valve 175 comprises a connection status indicator 300 of the filling device 5. The indicator 300 consists of a lens 305 and a piston 310. The indicator 300 is housed in the housing 295 and protrudes into the front chamber 285. The piston 310 is mobile, relative to the housing 295, parallel to the main axis X1 between a forward position and a retracted position wherein the piston 310 protrudes less into the front chamber 285 than in the forward position. The indicator 300 is pushed towards its forward position by a first spring 315. The lens 305 changes depending on the position of the piston 310.

Advantageously, the external radial surface 260 of the valve 175 comprises at least one first groove 320. In this example, five grooves 320 are provided on the external radial surface 260. Each of the grooves 320 extends parallel to the main axis X1. The grooves 320 are centered and evenly distributed around the main axis X1.

Advantageously, the external radial surface 260 of the valve 175 comprises at least one second groove 325. In this example, five grooves 325 are provided on the external radial surface 260. Each of the grooves 325 extends parallel to the main axis X1. The grooves 325 are centered and evenly distributed around the main axis X1. More specifically, the grooves 325 and the grooves 320 are centered and evenly distributed around the main axis X1 with an alternation of the grooves 325 and grooves 320.

The valve 175 is mounted in the ball holder 15. More specifically, the valve 175 is received in the internal volume 47, the external radial surface 260 being in contact with the inner surface 40 and the external radial surface 190 being in contact with the first internal radial surface 115.

The valve 175 is mobile in translation parallel to the axis X1 relative to the ball holder 15 between a rear position and a front position.

When the valve 175 is in the rear position, the valve seat 110 closes the distribution passage 215. In other words, the front end 207 of the valve body 180 is received in the internal volume 125 of the valve seat 110 and the first internal radial surface 115 closes the distribution passage 215.

When the valve 175 is in the front position, the distribution passage 215 is clear and the valve seat 110 and the external radial surface 190 of the valve body 180 form an annular space fluidly connected to the vent channel 290. Thus, the front end 207 of the valve body 180 is selectively received in the receiving mouth 35 of the ball holder 15.

The filling device 5 comprises a locking ring 330. The locking ring 330 is tubular and centered around the main axis X1. The locking ring is delimited by an internal radial surface 335 and an external radial surface 340.

The locking ring 330 comprises a conical mouth 345 diverging towards the front in the forward direction A1.

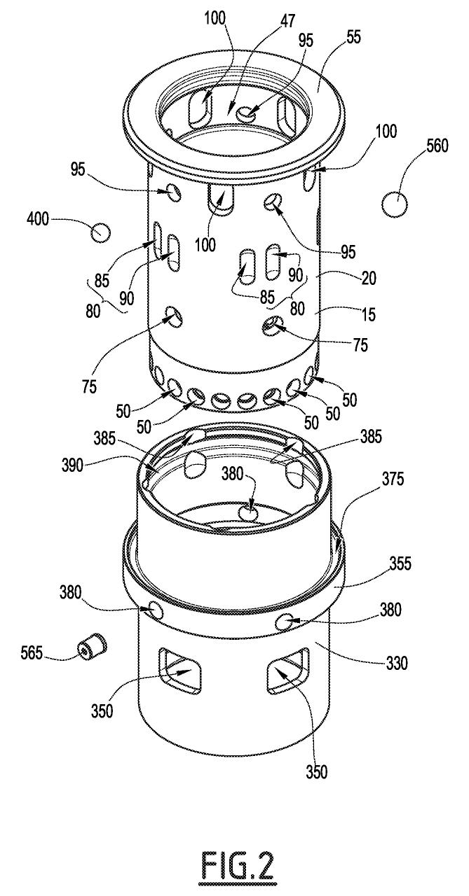

The locking ring 330 comprises four drillings 350. Each of the drillings 350 extends radially through the locking ring 330. The drillings 350 are centered and evenly distributed around the main axis X1. Each of the drillings 350 has a quadratic shape, clearly visible in FIG. 2. The drillings 350 are provided on the locking ring 330 at the rear, in the rearward direction A2, of the conical mouth 345.

The locking ring 330 comprises a collar 355. The collar 355 extends radially to the main axis X1 from the external radial surface 340 in a direction opposite to the main axis X1. The collar 355 defines an axial surface 360 facing in the forward direction A1, an axial surface 365 opposite to the axial surface 360, and an external radial surface 370 connecting the axial surface 360 to the axial surface 365. The collar 355 is provided on the locking ring 330 at the rear, in the rearward direction A2, of the drillings 350.

The collar 355 has a circular axial groove 375. The circular axial groove 375 is provided in the axial surface 365 and is centered around the main axis X1.

The collar 355 has five configuration housings 380, visible in FIG. 2. Each of the configuration housings 380 extends radially through the collar 355. The configuration housings 380 are centered and evenly distributed around the main axis X1.

Advantageously, the locking ring 330 comprises at least one oblong groove 385. In this example, five oblong grooves 385 are provided on the internal radial surface 335. Each of the oblong grooves 385 extends parallel to the main axis X1. The oblong grooves 385 are centered and evenly distributed around the main axis X1.

Advantageously, the locking ring 330 comprises an internal groove 390. The internal groove 390 is annular and provided on the internal radial surface 335 so as to connect the oblong grooves 385 to each other.

The locking ring 330 is mounted on the ball holder 15 so that the internal radial surface 335 is in contact with the external radial surface 45.

The drillings 350 are respectively in line with the drillings 75 and the drillings 150. Each of the stop fingers 155 respectively extends through one of the drillings 350. The quadratic shape of the drillings 350 allows both a relative translational movement, parallel to the main axis X1, of the locking ring 330 relative to the ball holder 15 and also a rotational movement, around the main axis X1, of the locking ring 330 relative to the ball holder 15. The translational and rotational movements are limited to ranges defined by the quadratic shape and a size of the stop fingers.

More specifically, the locking ring 330 is mobile in translation, parallel to the main axis X1, relative to the ball holder 15 between a blocking position and an unblocking position.

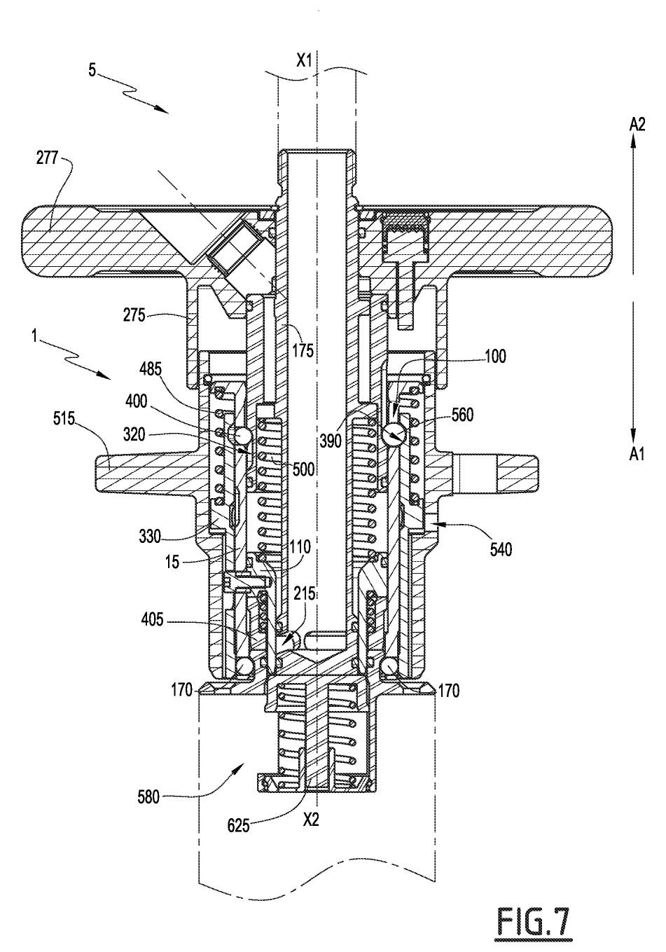

When the locking ring 330 is in the blocking position, the locking ring 330 is capable of maintaining the locking balls 170 in the locking position. More specifically, as shown in FIG. 7, when the locking ring 330 is in the blocking position, the locking ring 330 is advanced in the forward direction A1 relative to the ball holder 15 and the internal radial surface 335 is in contact with the locking balls 170 and pushes them radially towards the main axis X1 in their locking position.

When the locking ring 330 is in the unblocking position, the locking balls 170 are free to reach the retracted position. More specifically, as shown in FIG. 1, when the locking ring 330 is in the unblocking position, the locking ring 330 is retracted in the rearward direction A2 relative to the ball holder 15 and the conical mouth 345 is facing the locking balls 170, allowing the displacement of the locking balls 170 towards their retracted position.

The filling device 5 comprises at least one coupling ball 400. In this example, the filling device 5 comprises five coupling balls 400. Each of the coupling balls 400 is respectively received in a second radial housing 95. The coupling balls 400 are axially integral with the ball holder and are, respectively, mobile in translation radially relative to the ball holder 15 between a first position and a second position.

When a coupling ball 400 is in the first position, the coupling ball 400 protrudes from the associated second radial housing 95 into one of the grooves 320. The coupling ball 400 thus limits the displacement parallel to the main axis X1, of the valve 175 to a range defined by a longitudinal length of the associated groove 320. The coupling balls 400 are maintained in the first position when the locking ring 330 is in the unblocking position, the internal radial surface 335 being in contact with the coupling balls 400 and pushing them radially towards the main axis X1 in their first position.

When a coupling ball 400 is in the second position, the coupling ball 400 allows the displacement of the valve 175 towards its front position and maintains the locking ring 330 in the blocking position. More specifically, when the locking ring 330 is in the blocking position, the internal groove 390 is advanced, in the forward direction A1, facing the coupling ball 400, so that the displacement of the valve 175 towards its front position pushes the coupling ball 400 radially towards its second position in the internal groove 390. When the coupling ball 400 protrudes radially into the internal annular groove 390, the coupling ball 400 no longer protrudes into the associated groove 320.

When the valve 175 is in the front position, the external radial surface 260 blocks the coupling balls 400 in their second position and the coupling balls 400, both housed in the second radial housing 95 and received in the internal groove 390, prevent the translation of the locking ring 330 relative to the ball holder 15 and block the locking ring 330 in its blocking position.

The handle 275, the valve 175, and the ball holder 15 are considered as rotationally integral around the main axis X1 due to the mounting and friction elements.

The filling device 5 comprises a drawer 405. The drawer 405 is a revolution part centered on the main axis X1. The drawer 405 is delimited by an internal radial surface 410 and an external radial surface 415.

The drawer 405 comprises a front collar 420, which extends radially to the main axis X1 from the internal radial surface 410 in the direction of the main axis X1. The front collar 420 defines an axial surface 425 facing in the forward direction A1, an axial surface 430 opposite to the axial surface 425, and an internal radial surface 435 connecting the axial surface 425 to the axial surface 430.

The drawer 405 comprises a rear collar 440, which extends radially to the main axis X1 from the external radial surface 415 in a direction opposite to the main axis X1. The rear collar 440 defines an axial surface 445 facing in the forward direction A1, an axial surface 450 opposite to the axial surface 445, and an external radial surface 455 connecting the axial surface 445 to the axial surface 450.

The drawer 405 is mounted sliding in the annular space 153, the internal radial surface 435 being in contact with the external radial surface 115 and the external radial surface 415 being in contact with the internal radial surface 40.

The drawer 405 is mobile in translation, parallel to the main axis X1, relative to the ball holder 15 between an engaged position and a released position.

When the drawer 405 is in the engaged position, the drawer 405 is capable of maintaining the locking balls 170 in the retracted position. More specifically, when the drawer 405 is in the engaged position, the axial surface 445 is in front abutment against a shoulder 460 protruding from the inner surface 40 of the ball holder 15 and the external radial surface 415 is facing the first radial housings 50 blocking the radial translation of the locking balls 170 towards the main axis X1 and pushing the locking balls 170 into their unlocking position.

When the drawer 405 is in the released position, the locking balls 170 are free to reach their locking position. More specifically, when the drawer 405 is in the released position, the drawer 405 is pushed towards the rear, in the rearward direction A2, relative to the engaged position and advantageously rests axially on the ball holder 15. Indeed, the drawer 405 is pushed until the rear collar 440 is in rear abutment against the collar 130, so that the external radial surface 415 is retracted relative to the first radial housings 50 and does not obstruct the translation of the locking balls 170 from the retracted position to the locking position.

The filling device 5 comprises a first elastic member 470 capable of displacing the drawer 405 towards its engaged position. In this example, the first elastic member 470 is a spring. A first end 475 of the first elastic member 470 is housed in the circular axial groove 145 of the valve seat 110 of the ball holder 15 and a second end 480 of the first elastic member 470 is in contact with the axial surface 430 of the drawer 405. The first elastic member 470 pushes the drawer 405, in the forward direction A1, into its engaged position in abutment against the shoulder 460.

The filling device 5 comprises a second elastic member 485 capable of displacing the locking ring 330 from its unblocking position to its blocking position. In this example, the second elastic member 485 is a spring.

Advantageously, the second elastic member 485 rests on the ball holder 15. More specifically, a first end 490 of the second elastic member 485 is housed in the circular axial groove 70 of the ball holder 15 and a second end 495 of the second elastic member 485 is housed in the circular axial groove 375 of the locking ring 330. The second elastic member 485 pushes the locking ring 330, in the forward direction A1, from its unblocking position to its blocking position.

Advantageously, the filling device 5 comprises a third elastic member 500 capable of displacing the valve 175 towards its rear position. In this example, the third elastic member 500 is a spring. A first end 505 of the third elastic member 500 is in contact with the axial surface 225 of the collar 220 and a second end 510 of the third elastic member 500 is in contact with the collar 130 of the valve seat 110. The third elastic member 500 pushes the valve 175, in the rearward direction A2, towards its rear position.

Advantageously, the filling device 5 comprises a maneuvering ring 515. The maneuvering ring 515 is tubular and centered around the main axis X1. The maneuvering ring 515 is delimited by an internal radial surface 520 and an external radial surface 525. The internal radial surface 520 delimits a ring volume 530.

The maneuvering ring 515 comprises an internal shoulder 535 protruding into the ring volume 530.

The maneuvering ring 515 comprises five configuration ports 540. Each of the configuration ports 540 extends radially through the maneuvering ring 515 and opens into the ring volume 530. The configuration ports 540 are centered and evenly distributed around the main axis X1.

The maneuvering ring 515 comprises a collar 545. The collar 545 extends from the external radial surface 525 in a direction opposite to the main axis X1.

The maneuvering ring 515 is mounted around the locking ring 330. More specifically, the locking ring 330 is received in the ring volume 530, the internal shoulder 535 providing a front abutment to the collar 355 of the locking ring 330.

The maneuvering ring 515 is mobile in translation along the main axis X1 relative to the ball holder 15 between a forward position and a backward position.

When the maneuvering ring 515 is in the forward position and the locking ring 330 is in the blocking position, the locking ring 330 is entirely contained in the maneuvering ring 515 around the main axis X1. The locking ring 330 does not protrude from the ring volume 530.

The displacement of the maneuvering ring 515 relative to the ball holder 15 in the forward direction A1 is limited by a circlip 550 housed in a rear radial groove 555 of the maneuvering ring 515. The axial surface 65 of the ball holder 15 forms a front abutment to the circlip 550 and limits the displacement of the maneuvering ring 515 relative to the ball holder 15.

When the maneuvering ring 515 is in the backward position, the configuration ports 540 are respectively facing the configuration housings 380 of the locking ring 330.

The maneuvering ring 515, between its forward position and its backward position, can drive, by contact between the internal shoulder 535 and the collar 355, the locking ring 330 from its blocking position to its unblocking position.

Advantageously, the filling device 5 comprises safety means 560. In this example, the filling device 5 comprises five safety means 560. The safety means 560 are balls in this example.

The safety balls 560 are, respectively, housed in the oblong housings 100 of the ball holder 15. The safety balls 560 are free to displace parallel to the main axis X1 in the oblong housings 100. The safety balls 560 protrude radially on each side of the oblong housings 100. In particular, the safety balls protrude into the grooves 325 of the valve 175 and form an axial stop for the valve 175 relative to the ball holder 15 in the rear position of the valve 175.

The safety balls 560 are configured to take a first configuration and a second configuration. The filling device 5 is configured to take respectively a first and a second configuration. The filling device 5 is in its first configuration when the safety balls 560 are in their first configuration and the filling device 5 is in its second configuration when the safety balls 560 are in their second configuration.

When the safety balls 560 are in their first configuration, the safety balls 560 protrude radially into the internal groove 390 of the locking ring 330 so that the backward movement, in the rearward direction A2, of the valve 175 between an intermediate position, located relative to the ball holder 15 between the front position and the rear position, and the rear position, displaces the safety balls 560, in abutment against the grooves 325, in the oblong housings 100. The safety balls 560 then drive the locking ring 330 from the blocking position to the unblocking position.

When the safety balls 560 are in their second configuration, the safety balls 560 protrude radially into the oblong grooves 385 of the locking ring 330 so that the displacement of the locking ring 330 from the blocking position to the unblocking position is independent of the backward movement of the valve 175 between its front position and its rear position.

The filling device 5 comprises means for rotationally securing the maneuvering ring 515 and the locking ring 330. In this example, the securing means comprise at least one configuration housing 380 and a configuration port 540 capable of receiving a rod (not shown), of a diameter substantially smaller than the configuration housings 380 and the configuration ports 540. When the maneuvering ring 515 is in the backward position and the configuration ports 540 are facing the configuration housings 380, the rod is capable of being inserted into one of the configuration ports 540 and one of the configuration housings 380 securing in rotation around the main axis X1, the maneuvering ring 515 with the locking ring 330 so as to make the safety balls 560 change from their first configuration to their second configuration by a common rotational movement of the maneuvering ring 515 and the locking ring 330 relative to the ball holder 15. Each configuration housing 380 is therefore associated with a configuration port 540 facing the configuration housing 380.

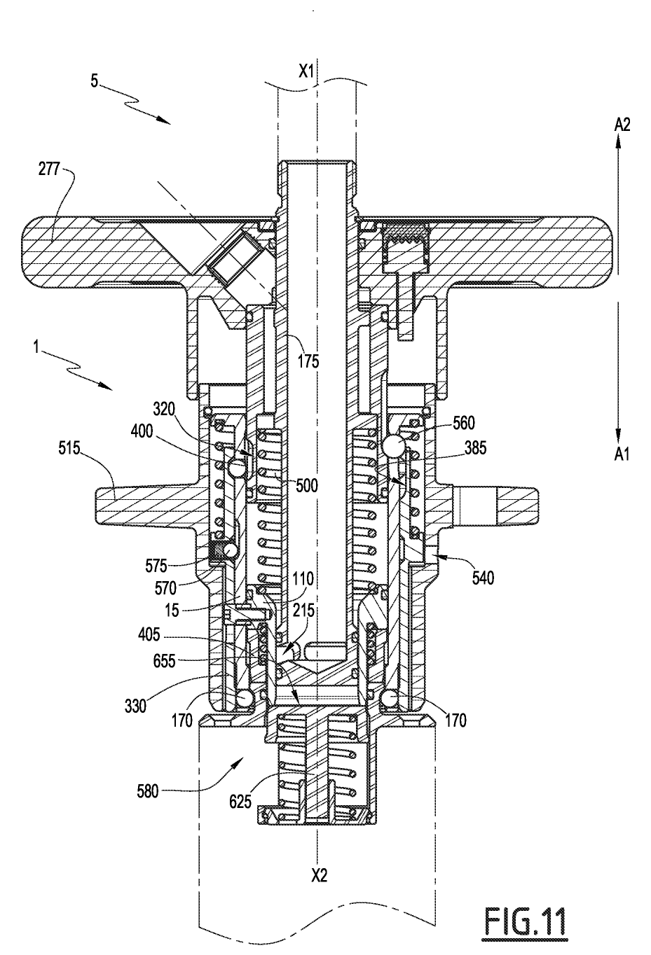

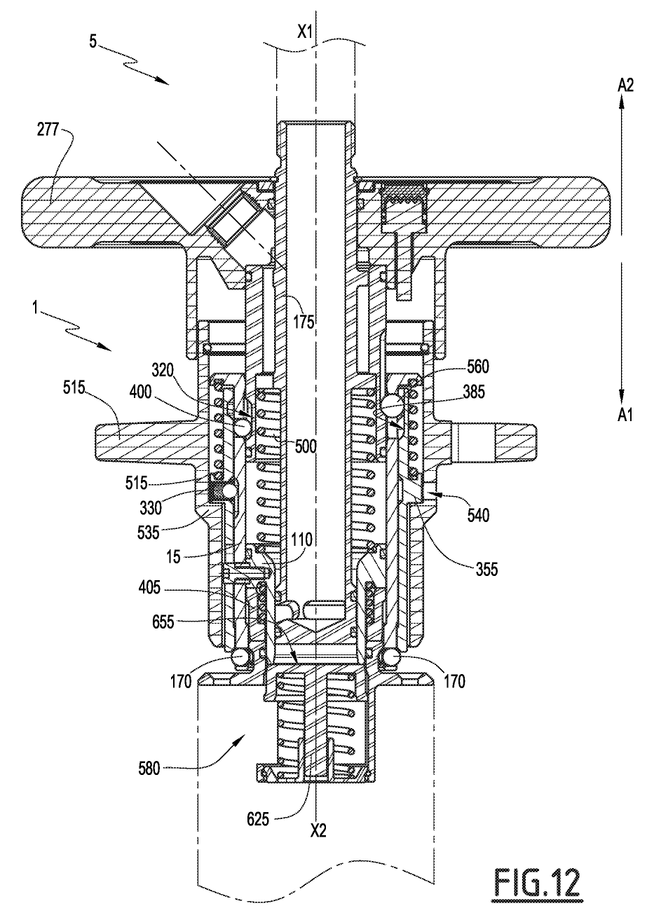

The filling device 5 also comprises one to four indexing balls 570, visible in FIGS. 11 and 12. Each indexing ball is respectively received in one of the five associated configuration housings 380. At least one configuration housing 380 remains free, i.e. capable of receiving a rod inserted into the associated configuration port 540. Each of the indexing balls 570 is pushed radially towards the main axis X1 by an associated second spring 575 contained in a pusher 565 positioned in the configuration housing 380. Each of the indexing balls 570 thus protrudes from the internal radial surface 335 into the longitudinal groove 85 or the longitudinal groove 90 of an associated pair of longitudinal grooves 80.

The safety balls 560 take the first configuration when the indexing balls 570 protrude into their respective longitudinal grooves 85 and the safety balls 560 take the second configuration when the indexing balls 570 protrude into their respective longitudinal grooves 90. The configuration of the safety balls 560 is therefore modified by a rotation of the locking ring 330, around the main axis X1, relative to the ball holder 15.

The filling assembly 1 also comprises an end 580. The end 580 is configured to be carried on the vehicle and is connected to the vehicle tank 3. The end 580 is the complementary fluid connection element, called male or end, to the filling device 5, the end 580 being insertable along the main axis X1 with the filling device 5 during a coupling of the end 580 and the filling device 5.

The end 580 comprises a body of the end 585 configured to push the drawer 405 of the filling device 5 from its engaged position to its released position during the coupling of the end 580 and the filling device 5. The body of the end 585 is tubular and centered around a secondary axis X2. The body of the end 585 is delimited by an internal radial surface 590 and an external radial surface 595. The internal radial surface 590 delimits a volume of the end 600 connected to the tank 3.

The body of the end 585 comprises an external peripheral groove 605 provided radially on the external radial surface 595. The external peripheral groove 605 is capable of receiving the locking balls 170, when the locking balls 170 are in the locking position.

The body of the end 585 also comprises a discal protrusion 610. The discal protrusion 610 extends radially from the external radial surface 595 in a direction opposite to the secondary axis X2. The external peripheral groove 605 is positioned, in the rearward direction A2, at the rear of the discal protrusion 610, the discal protrusion 610 partially delimiting the external peripheral groove 605. The discal protrusion 610 provides support and attachment means on the tank 3, so that the external peripheral groove 605 is positioned, in the rearward direction A2, at the rear and outside the tank 3.

The body of the end 585 comprises a front shoulder 615 protruding from the internal radial surface 590. The front shoulder 615 forms an end mouth 620 restricted relative to the volume of the end 600. The front shoulder 615 also forms a sealing seat of the body of the end 585.

The end 580 comprises a valve 625 formed of a tubular head 630 and a rod 635. The tubular head 630 is delimited by an internal radial surface 640, an external radial surface 645, an axial surface 650 directed in the forward direction A1 and extending from the internal radial surface 640, and an axial surface 655 opposite to the axial surface 650 and extending from the external radial surface 645.

The rod 635 is centered on the secondary axis X2 and extends in the forward direction A1 from the axial surface 650.

The valve 625 is received in the volume of the end 600. The valve 625 is mobile axially in the body of the end 585 between a forward position and a retracted position.

When the valve 625 is in the forward position, a rear shoulder 660 provided on the external radial surface 645 of the head 630 is in abutment against the front shoulder 615 of the body of the end 585, the valve 625 thus rests on the sealing seat 615 of the body of the end 585.

When the valve 625 is in the retracted position, the valve 625 is away, in the forward direction A1, from the sealing seat 615.

The sealing between the body of the end 585 and the valve 625 is ensured by a seal 663 positioned between the sealing seat 615 and the head 630.

The end 580 also comprises a guide seat 665. The guide seat defines a tubular guide volume 670 wherein the rod 635 is capable of sliding along the secondary axis X2. The guide seat 665 is mounted in the body of the end 585 and closes the volume of the end 600 opposite the tubular head 630. A displacement of the guide seat 665, in the forward direction A1, relative to the body of the end 585 is limited by a circlip 675 housed in an internal peripheral groove 680 of the body of the end 585.

The end 580 comprises a third spring 685 resting on the guide seat 665 on the one hand and on the axial surface 650 on the other hand. The third spring 685 pushes the valve 625 into its forward position.

The end 580 comprises a cover 690 provided with an O-ring 695. The cover is removable relative to the body of the end 585 and when it is mounted on the body of the end 585, the cover covers and protects the head 630 of the valve 625.

The steps of filling the tank 3 using the filling device 5 are described in the following description.

During the parking of a vehicle, for example a motorcycle, equipped with an end 580 at a fuel filling stand (not shown) and equipped with the filling device 5, the filling device 5 is brought closer to the end 580 of the vehicle. The end 580 is closed by its cover 690 and the filling device 5 maintains the valve 175 in the rear position on the valve seat 110 of the ball holder 15 so that the flow channel 195 is closed. The safety balls 560 are in their first configuration and the safety balls 560 are housed in the internal groove 390 of the locking ring 330.

As shown in FIG. 1, the filling assembly 1 is decoupled. The operator removes the cover 690 from the end 580 and aligns the filling device 5 with the end 580, the main axis X1 and the secondary axis X2 are then coaxial. The operator manipulates the filling device by grasping the wheel 277.

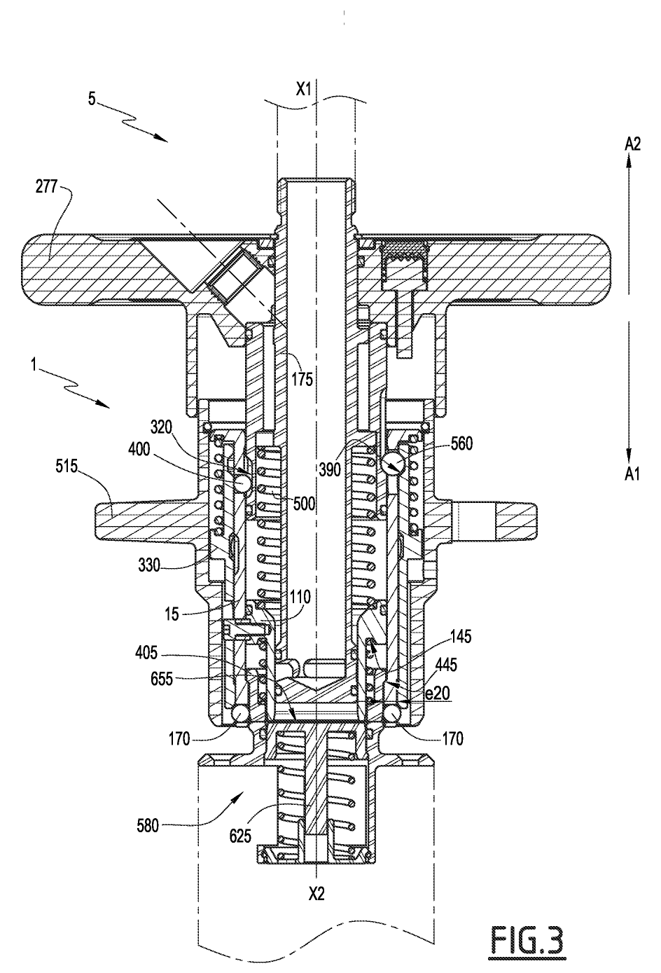

As shown in FIG. 3, the filling device 5 is then brought closer to the axial surface 655 of the valve 625, and the drawer 405 is brought into contact with the body of the end 585. The locking balls 170 are maintained in the retracted position by the drawer 405 in the engaged position. The locking balls 170 prevent the advancement of the locking ring 330, the locking balls 170 thus maintaining the locking ring 330 in the unblocking position. The safety balls 560 are in their first configuration and protrude radially into the internal groove 390 of the locking ring 330. The third elastic member 500 maintains the valve 175 in the rear position. The coupling balls 400 are maintained radially in the grooves 320 of the valve 175 by the locking ring 330, and block a backward movement, in the rearward direction A2, of the valve 175.

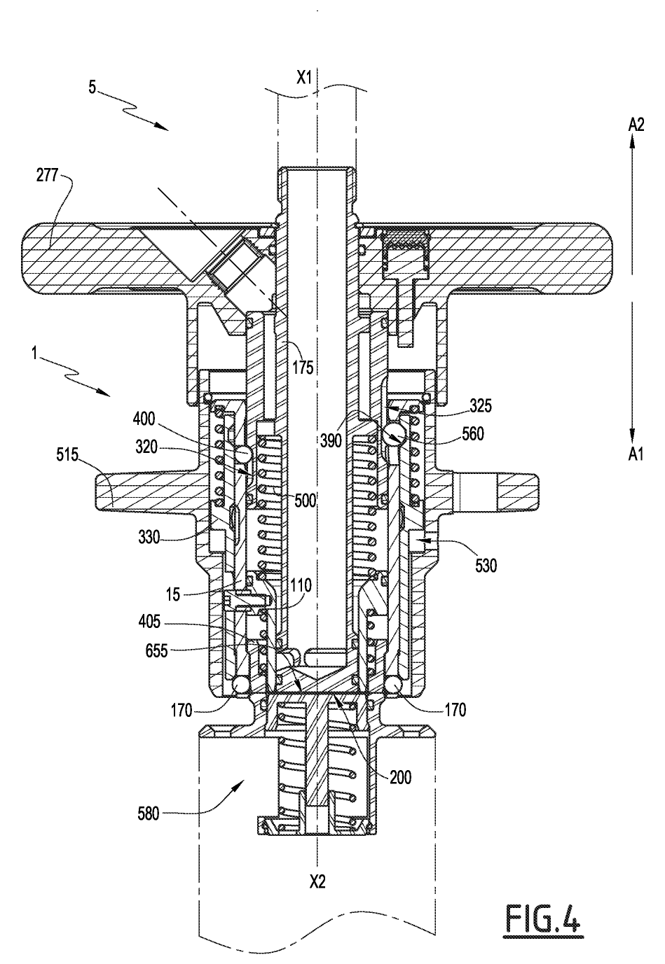

The operator pushes the wheel 277, in the forward direction A1, towards the end 580, as shown in FIG. 4. The front axial face 200 of the valve 175 comes into contact with the axial surface 655 of the valve 625. Due to the spring force 470 exerted on the drawer 405, the drawer 405 remains in the engaged position. The valve 175 advances relative to the ball holder 15, in the forward direction A1, in the range allowed by the grooves 320, to release the safety balls 560 from the stop of the grooves 325. The safety balls 560 are no longer constrained by the valve 175. The coupling balls 400 find a proximal stop in the grooves 320 of the valve 175. The valve 175 remains maintained in this position without being able to progress forward, in the forward direction A1, relative to the ball holder 15. The longitudinal length of the groove 320 corresponds to an overtravel range of the valve 175 relative to the locking ring 330, the valve coming into contact with the axial surface 655 of the valve without pushing it.

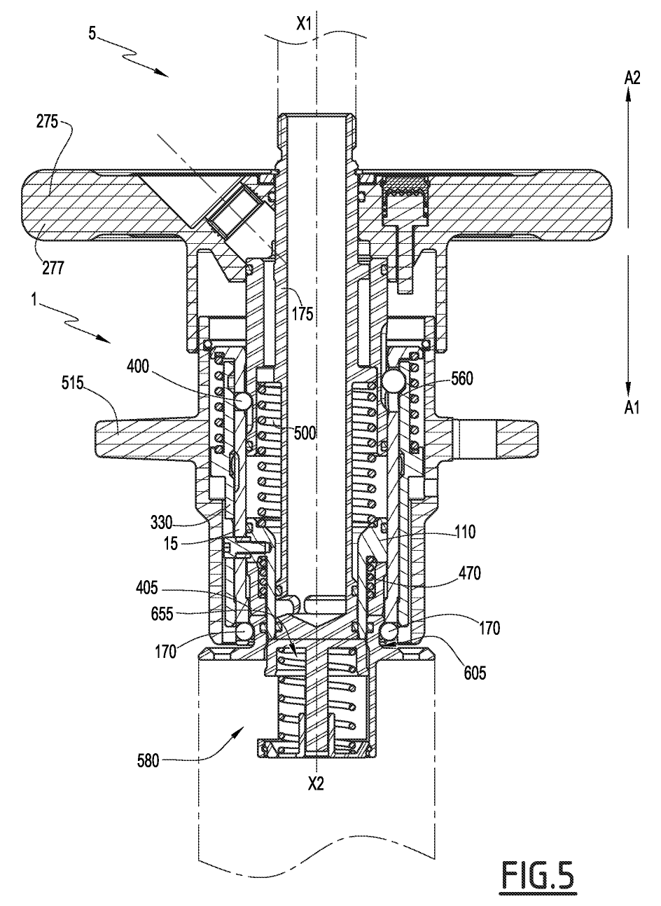

As shown in FIG. 5, the locking balls 170 are aligned with the external peripheral groove 605 of the body of the end 585 when the drawer 405 is pushed back, in the rearward direction A2, by the body of the end 585 against the force exerted by the first elastic member 470. The locking balls 170 are lodged in the external peripheral groove 605. The drawer 405 rests and is in rear abutment against the valve seat 110, marking the end of the approach of the filling device 5 relative to the end 580. Alternatively, especially if the spring force 470 is weak, the drawer 405 reaches its released position before the valve 175 advances relative to the ball holder 15.

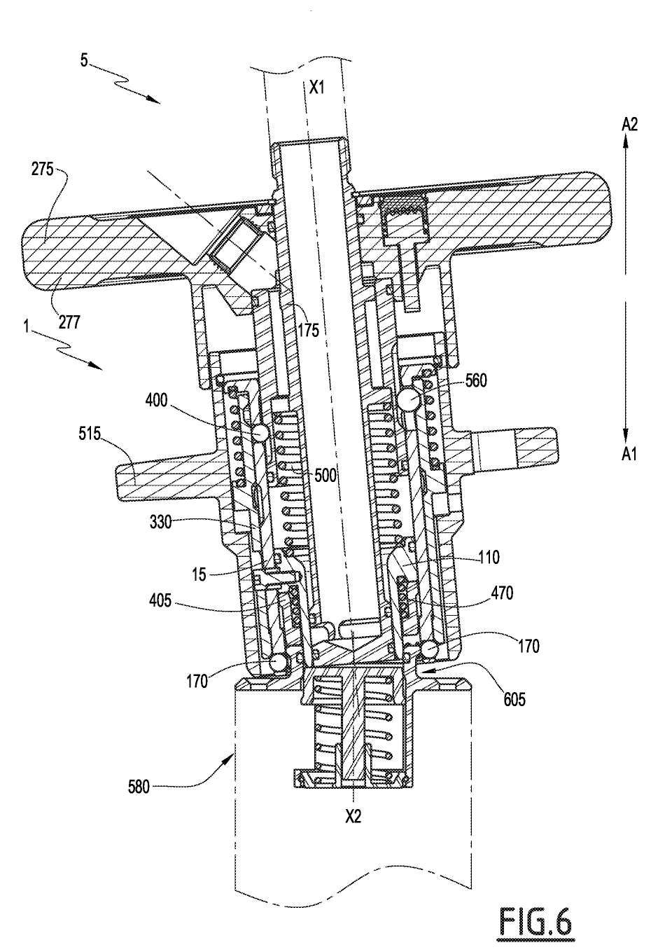

If the main axis X1 and the secondary axis X2 are not coaxial, as shown in FIG. 6, the body of the end 585 can push the drawer 405 and release certain locking balls 170 so that these locking balls 170 find a position in the external peripheral groove 605 of the end 580. However, other locking balls 170, visible in a plane perpendicular to the illustrated plane in particular, are in contact with an edge of the body of the end 585 and maintained in the retracted position, so that they maintain the locking ring 330 in the unblocking position and the coupling is not made possible.

Advantageously, the arrangement of the locking balls 170 and their small spacing limit the risk of poor connection of the filling device, which could have disastrous consequences in case of fuel spillage without the filling assembly 1 being actually coupled in a sealed manner. Thus, the locking balls 170 allow the locking phase to be secured since any locking ball 170 not engaged on the external peripheral groove 605 of the end 580 prevents the advancement of the locking ring 330 if the filling device 5 is not aligned with the end 580.

As shown in FIG. 7, the locking balls 170 no longer blocking the displacement of the locking ring 330, the locking ring 330 is driven forward, in its blocking position, by the second elastic member 485. The driving of the locking ring 330 by the second elastic member 485 allows locking without the need for external effort to the second elastic member 485 and makes it possible to maintain the filling device 5 locked on the end 580. This preliminary operation marks the locking step before the opening of the valve, which is safer compared to the state of the art.

The locking ring 330 reaches its blocking position, in abutment on the stop fingers 155. The advancement of the locking ring 330 drives the safety balls 560 forward and the safety balls 560 are in distal abutment in their oblong housing 100. The valve 175 remains in radial sealing contact against the valve seat 110. Indeed, when the drawer 405 moves from the engaged position to the released position, the valve 175 is maintained in the rear position by the third elastic member 500. Thus, the locking is performed before the distribution passage 215 is opened since a maneuver operation against the third elastic member 500 is made necessary and made possible only when the coupling balls 400 have been pushed into the internal groove 390 of the locking ring 330. Also, the range of displacement of the valve 175 allowed by the grooves 320 allows the locking of the locking ring 330 to be sequenced and the valve 175 to be opened. Moreover, the locking ring 330 is contained in the maneuvering ring 515 and is not accessible, which secures the locking.

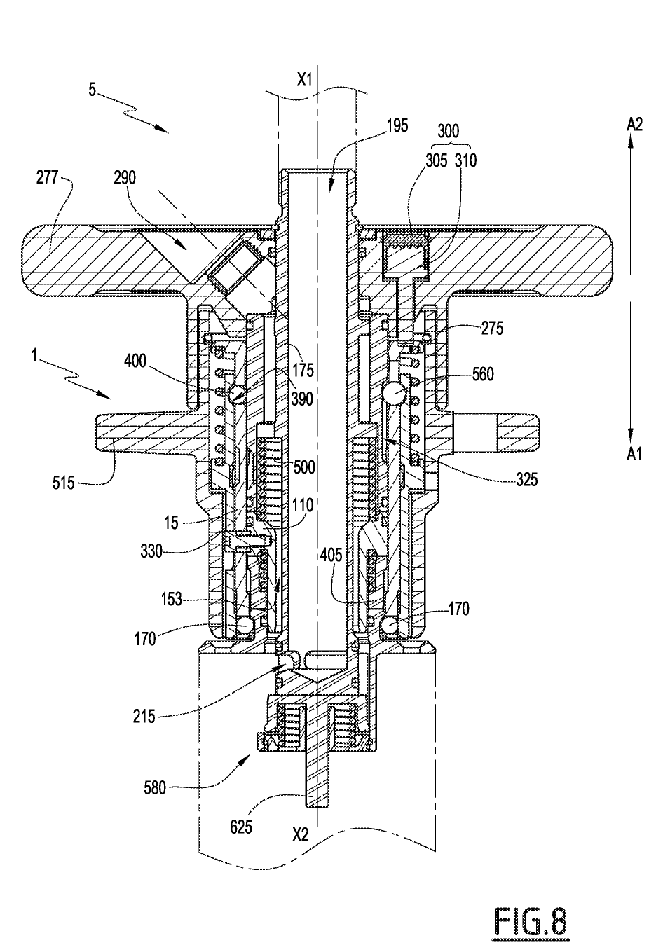

The operator continues the movement of bringing the wheel 277 and the end 580 closer. The external radial surface 260 of the valve 175 pushes the coupling balls 400 into the internal groove 390 of the locking ring 330, as shown in FIG. 8. The locking ring 330 is locked in the blocking position. The distribution passage 215 protrudes axially from the valve seat 110 so that once the valve 625 is pushed, the flow channel 195 is connected with the vehicle tank 3. The valve 175 is advanced to the maximum, and the valve 625 is pushed to the maximum so that a fluid vein space is defined between the two connection elements. The annular space 153 defined radially between the ball holder 15 and the valve 175 allows the passage of vents that reach the annular passages 265 in the central body 250 of the valve 175 then the vent channel 290 of the wheel 277. The vents are recycled according to the state of the art of the technical field. The filling device 5 is in a filling phase, i.e., fuel distribution.

During the maximum approach, the piston 310 of the indicator 300 is pushed towards the lens 305. In the forward position of the valve 175, the piston 310 rests on the crown 55 of the ball holder 15, which pushes it into a cooperation configuration with the lens 305 of the indicator 300. The lens 305 then displays a different color from the color displayed when the piston 310 is not in contact with the lens 305, i.e., when the valve 175 is not in the forward position. The indicator 300 thus indicates a connection status of the filling device 5, when the mutual approach of the handle 275 and the end 580 allows the vehicle to be filled with fuel. This display is useful to the operator who can realize if their pressure on the handle 275 is sufficiently applied to create an optimal fluid vein space.

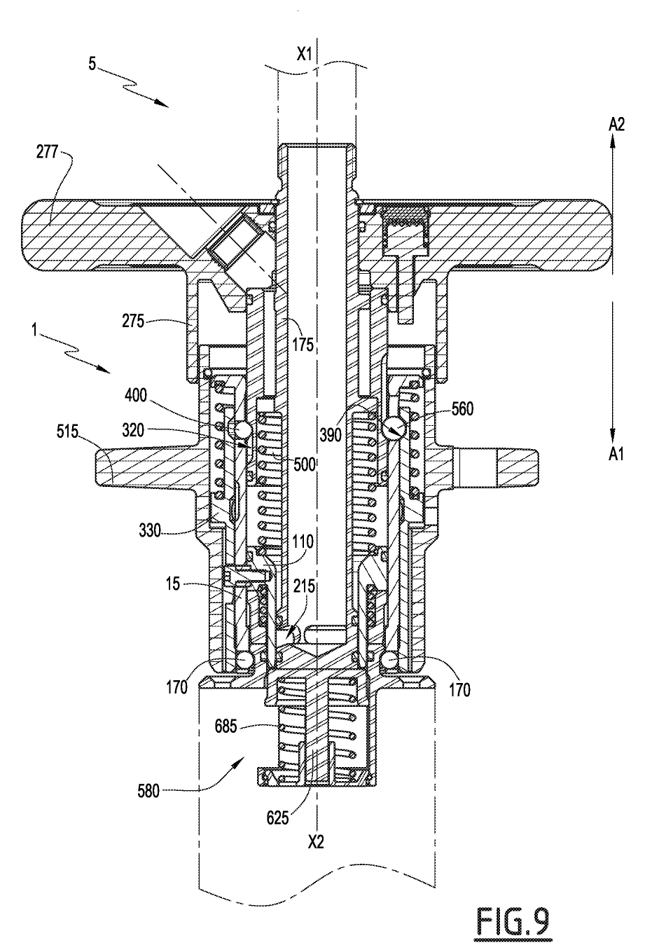

FIG. 9 represents a scenario where the operator releases the handle 275, in an incident situation, for example. The third elastic member 500 pushes the valve 175 towards the rear, in the rearward direction A2. The valve 175 is then in rear abutment against the safety balls 560 taken in the internal groove 390 of the locking ring 330, given that the safety balls 560 are in the first configuration. The valve 175 is in its intermediate position. The action of the third elastic member 500 brings the distribution passage 215 back in front of the valve seat 110, closing the distribution circuit. The third spring 685 also pushes the valve 625, in the forward direction A1, obstructing access to the tank 3.

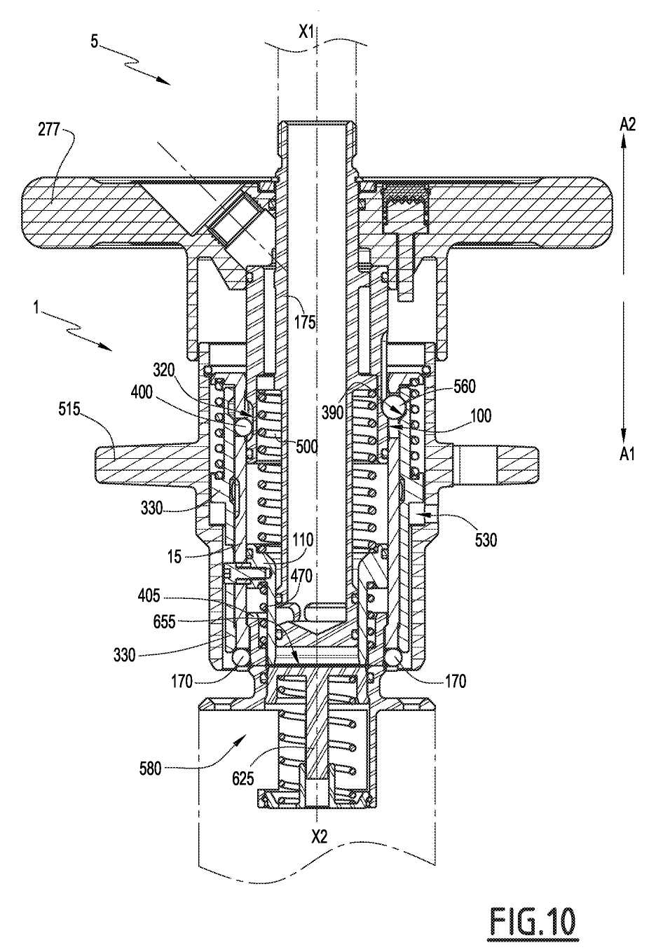

The third elastic member 500 pushes the valve 175 further towards the rear and drives the locking ring 330 from its blocking position to its unblocking position by means of the safety balls 560, which translate in the oblong housing 100 of the ball holder 15 as shown in FIG. 10. Thus, the safety balls 560 secure in translation the locking ring 330 and the valve 175 in the backward movement of the valve 175 from its front position to its rear position. This movement is performed in the overtravel range of the valve 175, associated with the axial length of the groove 320. The locking ring 330 by its retraction, in the rearward direction A2, pushes the coupling balls 400 into the grooves 320 of the valve 175 and radially constrains the coupling balls 400, which retain the valve 175 in the rear position. The retraction of the locking ring 330 also releases the locking balls 170 radially. The locking balls 170 reach the retracted position under the action of the first elastic member 470, which pushes the drawer 405 forward, in the forward direction A1. The action of the first elastic member 470 contributes to the separation of the filling device 5 and the end 580. The position reached is identical to the position shown in FIG. 3.

If the operator no longer holds the filling device 5 during the filling of the tank 3, the filling device 5 disconnects automatically and without dripping from the end 580. If the vehicle has started, the device is disconnected automatically.

Thus, in the first configuration of the safety balls 560, upon release of the filling device 5 by the operator during the filling step, the safety balls 560 act on the locking ring 330 to mechanically disconnect the filling device 5 from the end 580, as seen previously.

In the second configuration of the safety balls 560, the release of the filling device 5 will not cause disconnection, the safety balls 560 not acting on the locking ring 330.

The two configurations of the safety balls 560 appear under the same embodiment. However, the invention provides a first alternative filling device (not shown), which structurally comprises only the functional elements of the first configuration according to a second mode called "automatic." The invention provides a second alternative filling device ( not shown), which structurally comprises only the functional elements of the first configuration according to the first mode called "manual." These alternative embodiments dispense with the configuration means described.

To configure the safety balls 560 of the filling device 5 decoupled from the end 580, the maneuvering ring 515 must be retracted, in the rearward direction A2, until the configuration ports 540 are aligned with the configuration housings 380 of the locking ring 330. The rod is inserted into a configuration port 540 and the associated configuration housing to rotationally secure the locking ring 330 and the maneuvering ring 515. The configuration of the safety balls 560 is modified by a rotation of the locking ring 330 around the main axis X1 relative to the ball holder 15.

During the transition from one configuration to another, the indexing balls 'fall' into the associated grooves of the ball holder 15, which provides an audible passage indicator for the operator, from one or the other of the configurations.

In the following description, the safety balls 560 are in their second configuration and protrude into the oblong grooves 385 of the locking ring 330.

The first steps of filling the tank 3 for the filling device 5 are identical to the steps presented previously until the filling assembly is in the configuration shown in FIG. 17. The steps differ when the user releases the handle 275.

The third elastic member 500 pushes the valve 175 towards the rear, in the rearward direction A2, and brings the distribution passage 215 back in front of the valve seat 110, closing the distribution circuit. The valve 175 is then in rear abutment against the safety balls 560 and drives the safety balls 560 in backward displacement, in the rearward direction A2, in the oblong grooves 385, as shown in FIG. 11. The backward displacement of the safety balls 560 has no influence on the position of the locking ring 330 since the safety balls can displace parallel to the main axis X in the oblong grooves 385. The locking ring 330 is maintained in the blocking position by the second elastic member 485. If the filling device 5 is released by the operator, the filling device 5 remains coupled to the end 580.

The operator acts on the maneuvering ring 515 and exerts a pulling force in the rearward direction A2. The internal shoulder 535 abuts against the collar 355 and drives the locking ring 330 into its unblocking position, which releases the locking balls 170, as shown in FIG. 12. This step is conditional for the continuation of the disconnection, the advancement of the drawer 405, and the release of the filling device 5.

In an unshown variant, the safety balls 560 are replaced by another means of driving the locking ring 330.

In an unshown variant, the locking ring 330 and the maneuvering ring 515 are integral in translation.

In an unshown variant, the filling device 5 comprises an elastic member between the wheel 277 and the maneuvering ring 515, which pushes the maneuvering ring 515 forward.

In an unshown variant, the ball holder 15 does not comprise a crown and the second elastic member 485 rests on the wheel 277 of the valve 175. The maneuvering ring 515 is stopped in translation, parallel to the main axis X, alternatively to the circlip shown in its internal groove, for example using a stop finger abutting in a longitudinal groove of the wheel 277.

In an unshown variant, the locking balls are replaced by segments or a component of alternative geometry.

In an unshown variant, the internal groove 390 is replaced by a counterbore opening at the rear of the locking ring 330, so that the coupling balls 400 do not constrain the axial movement of the locking ring 330, in the second position of the coupling balls 400.

In an unshown variant, the valve 175 is driven by a lever and roller mechanism.

The present invention relates to a filling device (5) coupled with an end (580). The device comprises a ball holder (15) and a locking ball (170) movable between retracted and locking positions. A valve (175) is movable in the ball holder between rear and front positions. A locking ring (330) is movable between a blocking position that maintains the locking ball in the locking position, and an unlocking position. A coupling ball (400) is movable between a first position that prevents the valve from reaching its front position, and a second position. A drawer (405) is pushed by the end between an engaged position that maintains the locking ball in the retracted position, and a disengaged position. An elastic member (470) displaces the drawer to its engaged position, and an elastic member (485) displaces the locking ring to its blocking position.

Any feature described above for one embodiment or variant is applicable to the other embodiments and variants described above, as long as it is technically possible.

What is claimed is:

1. A fuel filling device, configured to be coupled with an end connected to a vehicle tank, the filling device comprising:
a ball holder, comprising:
a tubular ball holder body, extending along a main axis between a rear part and a front part of the ball holder body, the front part defining a receiving mouth of the end,
a tubular valve seat, extending in the receiving mouth of the ball holder body along the main axis,
at least one locking ball, received in a first radial housing provided in the front part of the ball holder body, and mobile in the first radial housing between a retracted position and a locking position wherein:
said at least one locking ball is radially less eccentric relative to the main axis than in the retracted position, and
said at least one locking ball protrudes into the receiving mouth,
a valve, comprising:
a valve body, which is tubular and extends along the main axis between a front end of the valve body, and a rear end of the valve body, the valve body defining an external radial valve surface and forming a flow channel capable of being fluidly connected to a rear filling line of the valve,
a distribution passage, connected to the flow channel and provided radially to the main axis at the front of the valve body, and
the valve being mounted in the ball holder so that:
the external radial valve surface is in contact with an inner surface of the ball holder body,
the valve is mobile in translation along the main axis relative to the ball holder between a rear position, wherein the valve seat closes the distribution passage, and a front position, wherein the distribution passage of the valve is clear,
a tubular locking ring surrounding the ball holder and being mobile between:
a blocking position, wherein the locking ring is capable of maintaining said at least one locking ball in the locking position, and
an unblocking position wherein said at least one locking ball is free to reach the retracted position,
at least one coupling ball, axially integral with the ball holder and mobile radially to the main axis between:
a first position, wherein said at least one coupling ball prevents the valve from reaching its front position, said at least one coupling ball being maintained in the first position when the locking ring is in the unblocking position, and
a second position, wherein said at least one coufpling ball allows displacement of the valve towards its front position,
a drawer, mobile in an annular space defined between an outer surface of the valve seat and the inner surface of the front part of the ball holder body, the drawer being configured to be pushed by the end along the main axis between:
an engaged position wherein the drawer is capable of maintaining said at least one locking ball in the retracted position, and
a released position wherein said at least one locking ball is free to reach its locking position,
a first elastic member capable of displacing the drawer from its released position to its engaged position, and
a second elastic member capable of displacing the locking ring from its unblocking position to its blocking position.

2. The device according to claim 1, wherein the second elastic member rests on the ball holder.

3. The device according to claim 1, wherein in the engaged position of the drawer said at least one locking ball in the retracted position is capable of maintaining the locking ring in the unblocking position.

4. The device according to claim 1, wherein the external radial valve surface is configured to maintain said at least one coupling ball in its second position when the valve is in the front position.

5. The device according to claim 1, comprising a third elastic member capable of displacing the valve towards its rear position, and of maintaining the valve in the rear position when the drawer moves from the engaged position to the released position.

6. The device according to claim 1, comprising a maneuvering ring, mounted around the locking ring and mobile in translation along the main axis, between a forward position and a backward position between which the maneuvering ring can drive the locking ring from its blocking position to its unblocking position.

7. The device according to claim 1, wherein the external radial valve surface comprises at least one groove extending parallel to the main axis, said at least one groove being capable of receiving said at least one coupling ball and allowing, when said at least one coupling ball is in its first position, a translation of the valve relative to the ball holder along the main axis over a range defined by a longitudinal length of said at least one groove.

8. The device according to claim 1, wherein:
the ball holder comprises at least one second radial housing provided at the rear of the first radial housing, said at least one coupling ball being capable of translating between its first and second positions through said at least one second radial housing,
the locking ring comprises an internal groove configured to receive said at least one coupling ball in its second position so that said at least one coupling ball maintains the locking ring in the blocking position.

9. The device according to claim 1, comprising safety means configured to take a first configuration and a second configuration so that, when the safety means are in their first configuration, the safety means are capable of driving the locking ring from the blocking position to the unblocking position in a backward movement of the valve between an intermediate position, located relative to the ball holder between the front position and the rear position, and the rear position.

10. The device according to claim 9, wherein, when the safety means are in their second configuration, the displacement of the locking ring from the blocking position to the unblocking position is independent of the backward movement of the valve between its front position and its rear position.

11. The device according to claim 9, wherein the safety means comprise a safety ball mobile in an oblong housing of the ball holder, protruding radially on each side of the oblong housing, and forming an axial stop for the valve relative to the ball holder in the rear position of the valve.

12. The device according to claim 11, wherein the locking ring comprises an internal groove configured to receive the safety ball, so that the locking ring is driven from the blocking position to the unblocking position by the safety ball resting on the valve during the backward movement of the valve, between its front position and its rear position.

13. The device according to claim 9, comprising means for securing a maneuvering ring with the locking ring, rotationally around the main axis, the safety means changing from their first to their second configuration by a rotational movement of the maneuvering ring relative to the ball holder.

14. The device according to claim 1, wherein the drawer rests axially on the ball holder in its released position.

15. The device according to claim 1, wherein, when the valve is in the front position, the valve seat and the valve form an annular space fluidly connected to a vent channel provided at the rear of the device.

16. A vehicle fuel tank filling assembly, the assembly comprising an end, configured to be mounted on the vehicle and connected to a vehicle tank, and a filling device according to claim 1 capable of being coupled to the end, the end comprising:
an end body configured to push the drawer of the filling device from its engaged position to its disengaged position during a coupling of the end and the filling device, the end body comprising an external peripheral groove capable of receiving said at least one locking ball, when said at least one locking ball is in the locking position, and
a valve axially movable in the end body between an advanced position, wherein the valve rests on a sealing seat of the end body, and a retracted position, wherein the valve is away from the sealing seat.
